(19) United States
(12) Patent Application Publication
(10) Pub. No.: US 2024/0325990 A1
(43) Pub. Date: Oct. 3, 2024

(54) ATOMIC LAYER DEPOSITION OF FILTRATION MEDIA

(71) Applicant: Donaldson Company, Inc., Bloomington, MN (US)

(72) Inventors: David D. Lauer, Minneapolis, MN (US); Davis B. Moravec, Burnsville, MN (US)

(21) Appl. No.: 18/622,001

(22) Filed: Mar. 29, 2024

Related U.S. Application Data
(60) Provisional application No. 63/456,344, filed on Mar. 31, 2023.

(51) Int. Cl. B01D 69/14; B01D 67/00; B01D 71/36

(52) U.S. Cl. CPC B01D 69/148; B01D 67/0072; B01D 71/36

(57) ABSTRACT

Articles containing coated porous substrates and methods of making and using the same are provided. The article may be a filter media. The article includes a porous substrate with a non-reactive base polymer; a reactive polymer disposed on at least a portion of the base polymer, the reactive polymer having a surface energy that is higher than a surface energy of the non-reactive base polymer; and a compound comprising a metal disposed on at least a portion of the reactive polymer. The compound may be disposed on the reactive polymer using vapor deposition.

### CROSS-REFERENCE TO RELATED APPLICATIONS

This application claims the benefit of U.S. Provisional Patent Application No. 63/456,344, filed Mar. 31, 2023, which is incorporated herein by reference in its entirety.

### FIELD

The present disclosure provides filter media and methods of making such filter media. In particular, the present disclosure provides filter media for fluid (e.g., a gas or a liquid) filtration applications and methods of making such filter media.

### SUMMARY

The present disclosure provides filter media and methods of making such filter media. In particular, the present disclosure provides filter media for fluid (e.g., a gas or a liquid) filtration applications and methods of making such filter media.

In one embodiment, there is provided a filter media that includes a porous substrate including a non-reactive base polymer; a reactive polymer disposed on at least a portion of the base polymer; and a compound including a metal conformally disposed on at least a portion of the reactive polymer.

In another embodiment of the present disclosure, there is provided a method of separating a species, such as a contaminant, from a fluid. The method includes exposing the filter media as described herein to a fluid including the species to capture the species on the filter media.

In another embodiment of the present disclosure, there is provided a method of making the filter media as described herein. The method includes contacting at least a portion of a non-reactive base polymer with a mixture to form a coated base polymer and disposing a coating compound on at least a portion of the coated base polymer to form the filter media.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### Definitions

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, the terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “alkyl” is used here to refer to a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Examples of “alkyl” groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, norbornyl, and the like.

The term “alkylene” refers to a divalent group that is a radical of an alkane and includes groups that are linear, branched, cyclic, bicyclic, or a combination thereof. Unless otherwise indicated, the alkylene group typically has 1 to 30 carbon atoms. In some embodiments, the alkylene group has 1 to 20 carbon atoms, 1 to 10 carbon atoms, 1 to 6 carbon atoms, or 1 to 4 carbon atoms. Examples of “alkylene” groups include methylene, ethylene, propylene, 1,4-butylene, 1,4-cyclohexylene, and 1,4-cyclohexyldimethylene.

The term “heteroatom” refers to a heteroatom (e.g., oxygen, sulfur, or nitrogen) that replaces at least one carbon atom in an alkyl, alkylene, or other carbon-containing group or molecule. For example, ether groups contain one hetero oxygen atom with at least one carbon atom on each side of the oxygen atom.

The terms “comprises” and “includes” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The term “substantially” as used here has the same meaning as “significantly,” and can be understood to modify the term that follows by at least about 90%, at least about 95%, or at least about 98%. The term “substantially free” of a particular compound means that the compositions of the present invention contain less than 1,000 parts per million (ppm) of the recited compound.

The term “not substantially” as used here has the same meaning as “not significantly,” and can be understood to have the inverse meaning of “substantially,” i.e., modifying the term that follows by not more than 25%, not more than 10%, not more than 5%, or not more than 2%.

The term “about” is used here in conjunction with numeric values to include normal variations in measurements as expected by persons skilled in the art, and is understood to have the same meaning as “approximately” and to cover a typical margin of error, such as +5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Any direction referred to here, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

The phrases “at least one of” and “comprises at least one of” followed by a list refer to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Also herein, the recitations of numerical ranges by endpoints include all numbers subsumed within that range as well as the endpoints (e.g., 1 to 5 includes 1, 1.5, 2, 2.75, 3, 3.80, 4, 5, etc.). Herein, “up to” a number (e.g., up to 50) includes the number (e.g., 50).

The term “in the range” or “within a range” (and similar statements) includes the endpoints of the stated range.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the invention. Thus, the appearances of such phrases in various places throughout this specification are not necessarily referring to the same embodiment of the invention. Furthermore, the particular features, configurations, compositions, or characteristics may be combined in any suitable manner in one or more embodiments.

### BRIEF DESCRIPTION OF THE FIGURES

FIG. 1A is a schematic cross sectional view of a filter media according to an embodiment of the present disclosure.

FIG. 1B is a schematic cross sectional view of a filter media with a coated base layer according to an embodiment.

FIG. 2 is a schematic cross-sectional view of a filter including the filter media of the present disclosure.

FIGS. 3A and 3B are SEM images of a base material without coating and with PVOH coating. 1 μm×15,000

FIG. 4A is an SEM image of a sample prepared without PVOH and with 100 deposition cycles of Al₂O₃ in Example 2.

FIG. 4B is an SEM image of a sample prepared with PVOH and with 100 deposition cycles of Al₂O₃ in Example 2.

FIG. 4C is an SEM image of a sample prepared without PVOH and with 100 deposition cycles of Al₂O₃ in Example 2.

FIG. 4D is an SEM image of a sample prepared with PVOH and with 100 deposition cycles of Al₂O₃ in Example 2.

FIG. 4E is an SEM image of a sample prepared without PVOH and with 300 deposition cycles of Al₂O₃ in Example 2.

FIG. 4F is an SEM image of a sample prepared with PVOH and with 300 deposition cycles of Al₂O₃ in Example 2.

FIG. 4G is an SEM image of a sample prepared without PVOH and with 300 deposition cycles of Al₂O₃ in Example 2.

FIG. 4H is an SEM image of a sample prepared with PVOH and with 300 deposition cycles of Al₂O₃ in Example 2.

FIGS. 5A and 5B are plots showing the mean flow pore (μm) as a function of cycles for different atomic layer deposition including Al₂O₃ and TiO₂ on ePTFE without and with PVOH.

FIG. 6A is a plot showing the water flux ratio (% compared to PVOH coated) as a function of atomic layer deposition cycles of samples prepared in Examples 2 and 3.

FIG. 6B is a column diagram showing the comparison of the water flux in different atomic layer deposition cycles of samples prepared in Examples 2 and 3.

FIG. 7 is a column diagram showing the EDX analysis on the weight percent of different elements in samples prepared in Example 2.

FIG. 8A is an SEM image of a sample prepared without PVOH and with 150 deposition cycles of TiO₂ in Example 3.

FIG. 8B is an SEM image of a sample prepared with PVOH and with 150 deposition cycles of TiO₂ in Example 3.

FIG. 8C is an SEM image of a sample prepared without PVOH and with 150 deposition cycles of TiO₂ in Example 3.

FIG. 8D is an SEM image of a sample prepared with PVOH and with 150 deposition cycles of TiO₂ in Example 3.

FIG. 8E is an SEM image of a sample prepared without PVOH and with 500 deposition cycles of TiO₂ in Example 3.

FIG. 8F is an SEM image of a sample prepared with PVOH and with 500 deposition cycles of TiO₂ in Example 3.

FIG. 8G is an SEM image of a sample prepared without PVOH and with 500 deposition cycles of TiO₂ in Example 3.

FIG. 8H is an SEM image of a sample prepared with PVOH and with 500 deposition cycles of TiO₂ in Example 3.

FIG. 9A is a plot showing the permeability measurements as a function of atomic layer deposition cycles of TiO₂ taken at 1250 Pa and adjusted to 125 Pa on ePTFE with/without PVOH in Example 3.

FIG. 9B is a column diagram showing the comparison of permeability in different atomic layer deposition cycles of TiO₂ in Example 3.

FIG. 10 is a column diagram showing the EDX analysis on the weight percent of different elements in samples prepared in Example 3.

FIG. 11 is a column diagram showing the TGA analysis of samples prepared in Example 3.

### DETAILED DESCRIPTION

The present disclosure relates to filter media and methods of making such filter media. In particular, the present disclosure relates to filter media and methods of making filter media for fluid (e.g., a gas or a liquid) filtration applications and methods of making such filter media. According to embodiments of the present disclosure, a less reactive (e.g., non-reactive) base material may be coated with a more reactive coating prior to deposition of a metal-containing coating on the material.

Atomic layer deposition (ALD) is a technique for growing thin films for a wide range of applications. ALD can be used to grow films (e.g., metal oxide films) on a surface. ALD is a type of chemical vapor deposition (CVD) technique where precursors are introduced into a reaction chamber in gaseous form for forming the desired material via chemical surface reactions. The mechanisms of ALD reactions involve the transfer of atoms between precursor vapors and surfaces. The transferred atoms may include, for example, hydrogen, oxygen, fluorine, and chlorine. The precursors react with the surface of a material one at a time in a sequential, self-limiting manner. At the temperature of a given ALD process, a precursor should react with the growth surface but not itself, which leads to the self-limiting characteristic of ALD. Most ALD processes typically involve two or more precursors, each containing different elements of the materials being deposited. The two or more precursors are typically introduced to the substrate surface separately, one at a time. It may be desirable for each precursor to saturate the surface forming a monolayer of material. A first gas including the first precursor may be introduced into the reaction chamber containing the surface to be treated. Once the surface is covered by a monolayer of the first gas, saturation is reached. The excess gas is pumped out of the reaction chamber, and a second gas containing a second precursor is introduced. The second gas condenses and is chemisorbed on top of the first layer. The excess second gas is pumped away. The whole process may be repeated to deposit a second monolayer. This sequence can be repeated as many times as necessary until the desired thin film is slowly deposited through repeated exposure to separate precursors. To be suitable in the process, it is desirable for ALD precursors to have specific properties such as sufficient volatility, thermal stability, and self-limited reactivity with surfaces. Suitable pairs of precursors can deposit some pure elements, oxides of most elements, nitrides of many elements, sulfides, selenides, and tellurides of some elements, and phosphides, arsenides, carbides, fluorides of few elements, and combinations thereof.

ALD can preserve the fundamental structure of the underlying surface (e.g., base layer) by adding conformal coatings that are self-limiting in nature, while changing the physical and/or chemical nature of the surface. Both of these changes can impact the physical and chemical performance of the media and provide additional applications that the media may be suited for. Base layers frequently bind the precursors with some affinity to allow adherence to the base layer. In ALD, the base layer serves as a surface for the first layer to bind to such that it is not lost when exposed to the second or third set of precursors. A wide variety of base layers may be used depending on the reaction and the resulting coating of interest.

In some instances, it may be desirable to coat materials having a low surface energy. Surface energy is a term used to describe the properties of the surface of a given substrate. High surface energy implies a strong molecular attraction, whereas low surface energy implies weak molecular attraction. When ALD is used to coat a material with low surface energy, the low surface energy of the base layer may cause slow or insufficient binding of the first precursor, and may therefore cause the ALD process to begin very slowly and progress in a non-conformal manner.

PTFE is used in diverse fields from daily life to various industrial applications. PTFE may be used as a substrate for filter media due to its good thermal stability, superior chemical resistance, high mechanical strength, and low dielectric constant. PTFE porous membranes known as “ePTFE” are manufactured using a stretching process. ePTFE stands for expanded polytetrafluoroethylene, which may be provided as a porous membrane. ePTFE may form one or more layers of filter media and may be used in filters for air and solvent purification. However, the strong hydrophobicity of ePTFE may decrease its performance when used in contact with water. PTFE has a low surface energy due to the high density of fluorine on the surface. This can make the initiation step of the ALD process challenging when a precursor is deposited onto a PTFE surface. To produce a coating using ALD on low surface energy materials, such as PTFE, an increased number of deposition cycles are needed, which increases the cost and time for making such coatings. Further, it may be difficult to produce a conformal coating on low surface energy materials by ALD. As used herein, the term “conformal” refers to a coating that follows the surface contours of the base layer so that the coating is present on the whole surface irrespective of surface roughness or defects. The term “non-conformal” refers to a coating that does not follow the surface contours of the base layer and is not present on the whole surface irrespective of surface roughness or defects. When comparing conformal and non-conformal coatings, it may sometimes be observed that the conformal coating is smoother and more evenly distributed across the surface, while the non-conformal coating is more nodular and unevenly distributed.

Metal oxides such as Al₂O₃ and TiO₂ are highly hydrophilic due to their high surface energy. The term “hydrophilicity” as used here has the same meaning as “hydrophilic,” and can be understood to have the meaning of “a tendency to mix with, dissolve in, or be wetted by water”, and can be understood to have the inverse meaning of “hydrophobic.” The term “oleophobic” as used here has the meaning of “lacking affinity for oils,” and can be understood to have the inverse meaning of “oleophilic”. Hydrophobic materials are defined as materials with a water contact angle greater than 90°, while hydrophilic materials are defined as materials with a water contact angle less than 90°. Hydrophilicity can be measured by measuring the water contact angle of a material using ASTM D7334-08R22 test method, or by using an automated contact angle tester and ASTM D5725-99 test method.

It has been discovered that the ALD deposition of Al₂O₃ or TiO₂ on PTFE can be used to increase the hydrophilicity of the PTFE surface. However, it would be desirable to improve the adhesion between the deposited layer and PTFE substrates. When metal oxides are deposited onto substrates that have low surface energy, the resulting deposits may be highly nodular and exhibit an uneven distribution of the deposited metal oxide. It would be desirable to provide an improved method of applying metal oxides onto low surface energy materials by ALD. It would be desirable to apply metal oxides to substrates in a more even layer. Thus, there is a need to modify the physical and chemical properties of low surface energy materials when adding metal oxide coatings by controlling the surface energy of the base layer.

According to embodiments of the present disclosure, the surface properties of low surface energy material may be modified by adding an intermediate coating of higher surface energy material to prepare the surface for the chemical vapor deposition of a metal oxide.

### Filter Media

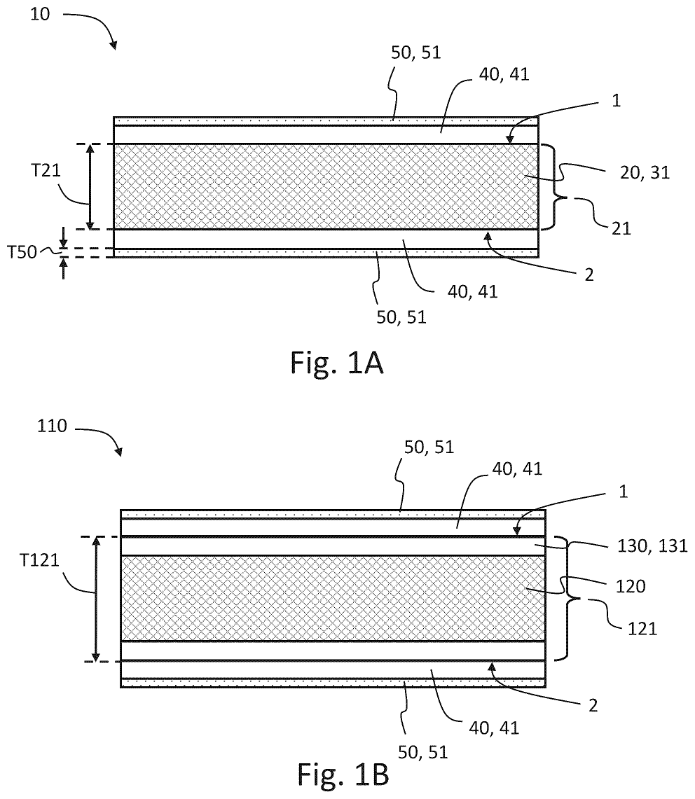

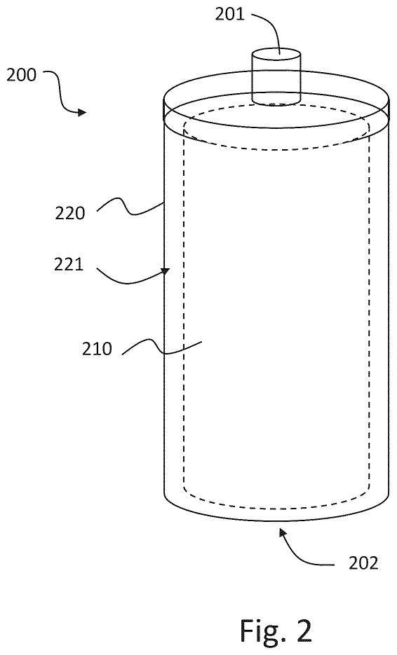

Reference is now made to FIGS. 1A-2. The present disclosure describes coated filter media 10, filters 200 including the filter media 10, methods of making the filter media 10, and methods of using the filter media 10. It should be noted that although the figures show a coated filter media, the methods of the present disclosure may also be used to apply coatings to surfaces of other articles. In particular, the methods of the present disclosure may be useful for applying coatings onto articles that include a porous surface having a low surface energy that may benefit from the improved ability to form a conformal coating.

The filter media 10 of the present disclosure, as schematically shown in FIG. 1A, generally includes a porous substrate 20 that is coated with a compound 51 that includes a metal. According to an embodiment, the compound 51 including a metal is applied to the media as a coating 50 using ALD or other similar deposition method.

The porous substrate 20 may include a non-reactive base polymer 31. The non-reactive base polymer 31 may form the porous substrate 20, as shown in FIG. 1A. The porous substrate 20 made of the non-reactive base polymer 31 may be referred to as a base layer 21. According to an embodiment, a reactive layer 40 of a reactive polymer 41 may be disposed on at least a portion of the base layer 21. In some cases, the reactive layer 40 may coat the base layer 21 entirely, forming a conformal coating on the base layer 21. The reactive layer 40 of a reactive polymer 41 may be disposed on the non-reactive base polymer 31 that forms the porous substrate 20. The compound 51 that includes a metal may form a coating 50 disposed on at least a portion of the reactive layer 40. The non-reactive base polymer 31 may be a material having a low surface energy. A base polymer that has a low surface energy, such as no greater than 37 mN/m, may be considered to be “non-reactive.” The base polymer may have a surface energy that is as low as, for example, about 20 mN/m. In some cases, it may be desirable to coat a base polymer that has a higher surface energy, such as up to 40 mN/m. The reactive polymer 41 may be a material having a surface energy that is higher than the non-reactive base polymer 31. That is, the reactive polymer 41 may be selected based on the surface energy of the non-reactive base polymer 31 such that the reactive polymer 41 has a surface energy that is greater than the surface energy of the non-reactive base polymer 31. In some embodiments, the term “reactive polymer” refers to a material that has surface energy of 37 mN/m or greater.

In some embodiments, the filter media 110 includes a porous substrate 120 that is coated with a layer 130 of the non-reactive base polymer 131, as shown in FIG. 1B. The porous substrate 120 and layer 130 of non-reactive base polymer 131 together form a base layer 121. The porous substrate 120 may be made of any suitable material, including materials with low, intermediate, or high surface energy. The surface properties of the base layer 121 may be determined based on the properties of the non-reactive base polymer 131 that forms the layer 130 coating the porous substrate 120. The base layer 121 may have similar properties (e.g., low surface energy) as the base layer 21 shown in FIG. 1A. In order to apply a coating 50 of compound 51 including a metal on the base layer 121, the base layer 121 may be modified by adding a reactive layer 40 of a reactive polymer 41 onto the base layer 121. The reactive polymer 41 may coat at least a portion of the base layer 121. In some cases, the reactive layer 40 may coat the base layer 121 entirely, forming a conformal coating on the base layer 121. The coating 50 of compound 51 including a metal may be disposed on at least a portion of the reactive layer 40.

Generally, the porous substrate 20, 120 is not a solid layer. The porous substrate 20, 120 may have a fibrous structure such as a nonwoven media, or the structure of a porous membrane, or a sponge-like structure. Although the various layers or coatings 40, 50, 130 are shown as solid layers, the layers or coatings 40, 50, 130 may at least partially coat each fiber or porous surface of the porous substrate 20, 120. That is, the layers or coatings 40, 50, 130 may form a conformal coating on the porous substrate 20, 120.

In some embodiments, the base layer 21, 121 has a first major surface 1 and an opposing second major surface 2 and a thickness T21, T121 between the first and second major surfaces 1, 2. The thickness T21, T121 may be measured in a direction perpendicular to the first and second major surfaces 1, 2. At least a portion of the compound 51 including a metal is distributed throughout the thickness T21, T121. That is, the compound 51 including a metal may be found not only as a distinct layer on the surface of the base layer 21, 121, but may be found within the base layer 21, 121, such as on fibers and/or within pores. The compound 51 may form a conformal layer on the porous substrate 20, 120, at least partially coating fibers and/or pores of the porous substrate 20, 120. The amount of the compound 51 including a metal within the filter media 10, 110 may be determined, for example, by elemental analysis, such as thermogravimetrically using ASTM E1131-20. Elemental analysis of the cross section has identified the compound 51 including a metal through the thickness T21, T121 of the base layer 21, 121, including on the second major surface 2 of media. In some embodiments, the 20 wt-% or more of the compound 51 including metal is disposed within the thickness T21, T121 of the base layer 21, 121 as per the elemental analysis (e.g., ASTM E1131-20).

In some embodiments, the coating forms a pattern on the filter media 10, 110. The patterning may be achieved by any suitable method, such as blocking portions of the base layer 21, 121 prior to application of the reactive polymer 41, blocking portions of the reactive polymer 41 prior to application of the compound 51 including a metal by ALD, or by applying the reactive layer 40 or the coating 50 of the compound 51 including a metal in a pattern. Any suitable regular or irregular pattern may be used as desired. The filtered media 10, 110 may have a plurality of regions including the reactive layer 41 and the coating 50 of the compound 51 including a metal. In some embodiments, one area of the base layer 21, 121 is coated and another area is not coated. As such, the filter media 10, 110 may include a coated region or area including the coating 50 and an uncoated region or area not including the coating 50.

The filter media 10, 110 may have a permeability within a wide range. The permeability of the filter media 10, 110 may be affected by the porous substrate 20, 120, the layer 130 of non-reactive polymer 131, the reactive layer 40, and the coating 50. For example, the permeability of the filter media 10, 110 may be affected by the inherent permeability of the porous substrate 20, 120. The permeability of the filter media 10, 110 may also be affected by the thicknesses of the various layers and coatings 130, 40, 50. The permeability of the filter media 10, 110 may also be affected by the chemical composition of the various layers and coatings 130, 40, 50, in particular the coating 50 of the compound 51 including a metal. The permeability of the media may be measured by measuring its Frazier permeability as described in ASTM D737-18, using a Frazier Permeability Tester available from Frazier Precision Instrument Co. Inc., Gaithersburg, Maryland. The unit for Frazier permeability is 1 cfm/ft² at 0.5″ water pressure drop, which is equivalent to 0.5 cm³/s/cm² at 125 Pa. In some embodiments, the filter media 10, 110 has a permeability of 0.02 cm³/s/cm² or greater, 0.05 cm³/s/cm² or greater, 0.1 cm³/s/cm² or greater, 0.2 cm³/s/cm² or greater, 0.3 cm³/s/cm² or greater, or 0.5 cm³/s/cm² or greater. The permeability of the filter media 10, 110 may be 2 cm³/s/cm² or less, 1.5 cm³/s/cm² or less, 1.0 cm³/s/cm² or less, or 0.8 cm³/s/cm² or less.

### The Porous Substrate

Any suitable porous substrate may be coated using the methods of the preset disclosure. Further, any suitable porous substrate may be used in the filter media of the present disclosure. The coating methods of the present disclosure may be particularly suitable for porous substrates that are non-reactive and exhibit a low surface energy (e.g., below 37 mN/m), or that are coated with a material that is non-reactive and exhibits a low surface energy. When such substrates are prepared with a porous structure, they may be used as filter media 10. Exemplary porous substrates include a porous network of fibers (e.g., nonwoven media), a porous membrane, or another porous structure, such as ePTFE. The porous substrate may be made of a variety of materials, such as various polymers.

In some embodiments, the porous substrate or a coating on the porous substrate has a surface that exhibits low surface energy due to the inclusion of a non-reactive material (e.g., a non-reactive polymer).

The porous substrate or a coating on the porous substrate may have a relatively low surface energy, such as 37 mN/m or below, 35 mN/m or below, 32 mN/m or below, 30 mN/m or below, 25 mN/m or below, or 20 mN/m or below. The porous substrate or a coating on the porous substrate may exhibit the surface energy of a non-reactive material (e.g., polymer). In some embodiments, a non-reactive polymer has a surface energy of no more than 37 mN/m. In some embodiments, a non-reactive polymer has a surface energy of 37 mN/m or less. In some embodiments, a non-reactive polymer has a surface energy of about 32 mN/m. In some embodiments, a non-reactive polymer has a surface energy of about 20 mN/m.

The non-reactive base materials may include polytetrafluoroethylene (PTFE), expanded polytetrafluoroethylene (ePTFE), sulfonated tetrafluoroethylene, polyvinyl fluoride, oleophobic polyethersulfone (for example, PES coated with an oleophobic coating), polypropylene, non-woven polypropylene, polyethylene, ethylene-vinyl acetate, poly dimethyl siloxane, neoprene, polyisobutylene, poly methyl vinyl ether, polybutadiene, polypropylene glycol, any combination of two or more thereof (including mixtures and copolymers), nonwoven materials made thereof, and membranes made thereof. In some embodiments, the non-reactive material (e.g., polymer) includes an oleophobic polymer. In some embodiments, the non-reactive material includes an oleophobic treatment. In some embodiments, the non-reactive material includes an oleophobic polymer and olcophobic treatment. Suitable oleophobic polymers have little or no affinity for oil or completely repel oil, and thereby prevent or restrict oil from passing through the filter media 10. Oleophobicity of a material may be measured by AATCC Test Method 118-1997 Oil Repellency: Hydrocarbon Resistance Test. Typically, the oleophobic polymer demonstrates a contact angle greater than 90 degrees when tested with oil. Examples of oleophobic polymers include polymers made from perfluorooctanoic acid (PFOA), other perfluorinated carboxylic acids (e.g., C6, C4, C3, C2, and C1), and polydimethylsiloxane (PDMS). Examples of olcophobic treatments include coatings with oleophobic polymers.

Porous substrates coated with a low surface energy materials may include a base substrate (e.g., polymer) that does not exhibit a low surface energy. For example, the porous substrate may include a coated cellulose acetate fibrous network or membrane. Other examples of coated porous substrates include substrates made from polyester, polyethersulfone, polyvinylchloride, nylon, polyacrylic, polystyrene, polyurethane, cellulose, polyimide, acrylonitrile butadiene styrene, or a combination of two or more thereof.

It may be desirable to modify filter media 10 by applying metal oxides to the substrate 20 of the filter media 10 to enhance the hydrophilicity of the substrate 20.

In some embodiments, the porous substrate includes an expanded non-reactive base polymer. Examples of expanded non-reactive base polymers include ePTFE, (expanded polytetrafluoroethylene), ePP (expanded polypropylene), and ePE (expanded polyethylene).

In some embodiments, the porous substrate is or includes a porous membrane. In some embodiments, the porous substrate is or includes ePTFE. In some embodiments, the porous substrate is or includes a porous network of fibers.

The porous substrate may have any suitable pore size as desired. The pore size may be selected to accommodate an intended use and may be adjusted by adjusting the thickness of the layers (including non-reactive material layer, reactive layer, and ALD coating). In some cases, the substrate may be highly porous and have relatively large pores, such as a material suitable for use as a scrim. In other cases, the substrate may have very small pores, such as a material suitable for use in micro- or nanofiltration. In certain embodiments, the porous substrate has an average pore size of 1 mm or less, 100 μm or less, 10 μm or less, 1 μm or less, 0.1 μm or less, or 0.01 μm or less. The porous substrate may have an average pore size of 1 nm or greater, 5 nm or greater, 10 nm or greater, 0.1 μm or greater, 1 μm or greater, 10 μm or greater, or 100 μm or greater. The average pore size of the porous substrate may be in a range of 1 nm to 1 mm, 1 nm to 1 μm, 1 nm to 0.5 μm, 1 μm to 1 mm, or 100 μm to 1 mm. A method for measuring pore size is described in ASTM D6767-21.

### The Reactive Layer

The base layer includes a non-reactive base material, such as a non-reactive polymer. According to an embodiment, at least a portion of the base layer (including a porous substrate and optionally a coating of non-reactive material) is coated by a layer of reactive polymer.

In some embodiments, the reactive polymer has a surface energy that is higher than the surface energy of the non-reactive polymer. A higher surface energy enables a more even deposition and a stronger adhesion of the compound including a metal onto the substrate. The reactive polymer may be selected based on its surface energy as compared to the base polymer. For example, the reactive polymer may be selected to have a surface energy that is at least 2 mN/m higher than the surface energy of the base polymer. The surface energy of the reactive polymer may be at least 5 mN/m, at least 10 mN/m, or at least 15 mN/m higher than the surface energy of the base polymer. In some embodiments, the non-reactive base polymer has a surface energy of about 18-22 mN/m, and the reactive polymer has a surface energy of 30 mN/m or greater, 35 mN/m or greater, 37 mN/m or greater, 40 mN/m or greater, or 45 mN/m or greater. The surface energy of the reactive polymer may be up to 80 mN/m. In some embodiments, the non-reactive base polymer has a surface energy of about 35-38 mN/m, and the reactive polymer has a surface energy of 37 mN/m or greater, 40 mN/m or greater, or 45 mN/m or greater.

In some embodiments, the reactive polymer includes polyvinyl alcohol (PVOH), polymethylmethacrylate (PMMA), polyacrylic acid (PAA), polyhydroxyethylmethacrylate (pHEMA), poly(caprolactam), polyethylene terephthalate (PET), polyethyleneglycol (PEG), polysulfone (PS), polyacrylonitrile (PAN), polyacrylamide (PAM), and combinations of two or more thereof (including mixtures and copolymers).

Methods of coating the non-reactive base polymer with a reactive polymer material are conventional and well-known to those skilled in the art. For example, the porous substrate may be coated by immersing, dip coating, spraying, printing, or brushing a solution containing the reactive polymer onto the porous substrate. The porous substrate may be pre-wetted prior to coating. The coated substrate may be rinsed after coating. The coating may be dried and/or cured onto the porous substrate. In one exemplary embodiment, the porous substrate is prewetted using a water miscible solvent such as acetone, ethanol, or isopropanol. The solvent may be displaced with water. The substrate (still wet with water) may be placed in contact with a room temperature aqueous bath containing poly(vinyl alcohol). For example, the substrate may be placed in an aqueous bath containing 1-2 wt-% of fully (99%) hydrolyzed poly(vinyl alcohol) for at least 2 minutes. Room temperature is understood to mean a temperature of about 20° C. to 26° C. The substrate may then be rinsed. In some embodiments, the substrate may be rinsed with water and immersed in an aqueous solution of glutaraldehyde and H₂SO₄ at an elevated temperature. For example, the substrate may be immersed in an aqueous solution of 2 mM to 8 mM (e.g., about 5 mM) glutaraldehyde and 0.1 M to 0.5 M (e.g., about 0.25 M) H₂SO₄ at a temperature of 40° C. to 80° C. (e.g., about 60° C.) for 1 minute to 5 minutes (e.g., about 2 minutes).

According to embodiments, the surface is coated with a compound that includes a metal. The surface may be a porous surface. The surface may be the surface of a filter media. The coating may be applied onto the surface coated with a reactive polymer, by ALD or another deposition method.

In some embodiments, the coating compound may be metal-containing compounds. In some embodiments, the metal-containing compound is a pure metal, a metal oxide, metal alkoxide, amino metal, metal sulfide, metal fluoride, or any combination of two or more thereof. In some embodiments, the metal-containing compound is MₙXₘ, MₙOₘ, MₙNₘ, MₙSₘ, MₙCₘ, or MₙRₘ, where M is a metal, X is a halogen (such as fluorine, chlorine, or iodine), R is a carbon-containing group optionally substituted with one or more hetero atoms (e.g., oxygen, nitrogen, sulfur, or the like), n is an integer from 1 to 4 (e.g., 1 to 3, 1 to 2, or 1), and m is an integer from 1 to 6 (e.g., 1 to 5, 1 to 4, 1 to 3, 1 to 2, or 1). R may be an alkyl group, alkylene group, or a substituted alkyl or alkylene, such as an alkoxide group, an alkylamine group, an alkylamide group, or the like. R may be straight, branched, or cyclic, and may include straight, branched, and/or cyclic segments. R may be saturated or unsaturated. Exemplary metals include aluminum, calcium, copper, erbium, gallium, hafnium, iridium, lanthanum, magnesium, palladium, platinum, niobium, ruthenium, scandium, silicon (a metalloid), strontium, tantalum, titanium, vanadium, yttrium, ytterbium, zinc, zirconium, and the like. Exemplary metal-containing compounds include Al₂O₃, CaO, CuO, Er₂O₃, Ga₂O₃, HfO₂, La₂O₃, MgO, Nb₂O₅, Sc₂O₃, SiO₂, Ta₂O₅, TiO₂, VRn (e.g., vanadium acetylacetonate or vanadium cyclopentandienyl), V(OHR)ₙ (e.g., vanadium butoxide, vanadium ethoxide, vanadium methoxide, vanadium propoxide, or vanadium tetraethoxide), TiOHRₙ, Y₂O₃, Yb₂O₃, ZnO, ZrO₂, AlN, GaN, TaRn (e.g., pentakis(dimethylamino)tantalum), TiAlN, TiRn (e.g., tetrakis(dimethylamino)titanium, tetrakis(ethylmethylamino)titanium), TaC, TiC, Ir, Pd, Pt, Ru, ZnS, SrS, CaF₂, LaF₃, MgF₂, and SrF₂, and combinations of any two or more thereof, where R, n, and m are as above.

According to an embodiment, the filter media or other substrate includes one or more metal-containing compounds deposited by chemical vapor deposition onto the substrate. In some embodiments, chemical vapor deposition is ALD. When ALD is used, the metal-containing compound may be applied in the form of two or more precursors. A metal-containing precursor may subsequently be oxidized with an oxygen-containing precursor. Precursors for the metal-containing compounds include, for example, tetrakis(dimethylamino)titanium(iv), tetrakis(ethylmethylamino)titanium, cyclopentadienyl(cycloheptatrienyl)titanium(ii), pentamethylcyclopentadienyltitanium trimethoxide, pentamethylcyclopentadienyltris(dimethylamino)titanium(iv), tetrakis(diethylamino)titanium(iv), titanium(iv) n-butoxide, titanium (iv) t-butoxide, titanium (iv) chloride, titanium(di-i-propoxide)bis(acetylacetonate), titanium(iv) (di-i-propoxide)bis[brew], titanium(iv) ethoxide, titanium(iv) i-propoxide, tris(2,2,6,6-tetramethyl-3,5-heptanedionato)titanium(iii), hexakis(dimethylamino)dialuminum, aluminum acetylacetonate, aluminum s-butoxide, aluminum chloride, aluminum ethoxide, aluminum hexafluoroacetylacetonate, aluminum iodide, aluminum i-propoxide, aluminum i-propoxide, dimethylaluminum i-propoxide, tri-i-butylaluminum, triethylaluminum, triethyl(tri-sec-butoxy)dialuminum, diethyl(tetra-sec-butoxy) dialuminum, tetraethyl(di-sec-butoxy)dialuminum), trimethylaluminum, tris(2,2,6,6-tetramethyl-3,5-heptanedionato)aluminum, atricthylaluminium, titanium(IV) chloride, bis(cyclopentadienyl)dimethylhafnium, hafnium(IV) ethoxide, hexamethyldisiloxane, and combinations of two or more thereof.

The thickness of the coating (e.g., metal oxide coating) may be adjusted as desired. In some cases, a thicker coating may be desired, while in others, a very thin coating may be desired. In some embodiments, the filter media includes 1 wt-% or more, 2 wt-% or more, 5 wt-% or more, 10 wt-% or more, 15 wt-% or more, or 20 wt-% or more of the metal compound, given as amount of metal by weight of the total filter media, measured by thermogravimetric analysis (TGA). In some embodiments, the filter media includes 50 wt-% or less, 40 wt-% or less, 30 wt-% or less, 20 wt-% or less, 15 wt-% or less, 10 wt-% or less, or 5 wt-% or less of the metal compound, given as amount of metal by weight of the total filter media. The filter media may include from 2 wt-% to 50 wt-% of the metal compound, given as amount of metal by weight of the total filter media. ASTM-E1131-20 may be used to measure wt-% of the metal compound in the media by TGA.

The filter media may be prepared to have a suitable pore size as desired. The desired pore size may be selected to accommodate an intended use, and may be adjusted by adjusting the thickness of the layers (including non-reactive material layer, reactive layer, and ALD coating). In some cases, the filter media may be highly porous and have relatively large pores, such as a material suitable for use as a scrim. In other cases, the filter media may have very small pores, such as a material suitable for use in micro- or nanofiltration. In certain embodiments, the filter media has an average pore size of 1 mm or less, 100 μm or less, 10 μm or less, 1 μm or less, 0.1 μm or less, or 0.01 μm or less. The filter media may have an average pore size of 1 nm or greater, 5 nm or greater, 10 nm or greater, 0.1 μm or greater, 1 μm or greater, 10 μm or greater, or 100 μm or greater. The average pore size of the filter media may be in a range of 1 nm to 1 mm, 1 nm to 1 μm, 1 nm to 0.5 μm, 1 μm to 1 mm, or 100 μm to 1 mm. A method for measuring pore size is described in ASTM D6767-21.

The properties of the filter media may be further evaluated using, among other parameters, the water flux. Water flux may be measured according to the Water Flux Test described herein. In certain embodiments, the media has a water flux of 2000 L/m²/min/psi or less, up to 40 L/m²/min/psi, up to 1 L/m²/min/psi, or up to 0.1 L/m²/min/psi.

### Methods of Making

The coated substrates (e.g., coated filter media) of the present disclosure may be made by first applying a reactive layer including a reactive polymer onto a base layer, and then applying a compound containing a metal onto the reactive layer. The compound containing a metal may be applied by a deposition method, such as chemical vapor deposition, such as ALD.

As explained above, the porous substrate 20 or a coating 130 on the porous substrate includes a non-reactive base polymer 31, 131. The non-reactive base polymer or at least a portion of the non-reactive base polymer may optionally first be contacted with a wetting liquid. In some embodiments, the non-reactive base polymer 30 is wettable. As used herein, the term “wettable” refers to a material that allows a fluid to spread evenly across its surface. In the case of a porous wettable surface the fluid will penetrate into the material and spread evenly until the entire volume of the fluid has spread as far as it can. Wettability of materials may be measured by ASTM D7334-08R22 test method. Wetting liquid is or may include one or more water miscible solvent such as acetone, ethanol, ethylamine, ethylene glycol, acetonitrile, methanol, 1-propanol, pyridine, or isopropanol. In some embodiments, the non-reactive base polymer 31, 131 is polytetrafluoroethylene and the wetting liquid is isopropanol.

The non-reactive base polymer or at least a portion of the non-reactive base polymer is then contacted with a mixture to form a coated base polymer. The mixture may include a reactive polymer and a carrier. The mixture may be a solution of the reactive polymer in the carrier. The reactive polymer may include one or more of polyvinyl alcohol (PVOH), polymethylmethacrylate (PMMA), polyacrylic acid (PAA), polyhydroxyethylmethacrylate (pHEMA), poly(caprolactam), polyethylene terephthalate (PET), polyethyleneglycol (PEG), polysulfone (PS), polyacrylonitrile (PAN), polyacrylamide (PAM), and mixtures and copolymers thereof. The reactive polymer may be included in the mixture at a concentration of 0.25 wt-% to 5 wt-%. The carrier may include one or more solvents. The carrier may be selected such that the reactive polymer is soluble in the carrier. Alternatively, the reactive polymer may be partially dissolved or emulsified in the carrier. In such cases, the carrier may include one or more adjuvants, such as surfactants, dispersants, or the like. The carrier may further include a crosslinker. A suitable crosslinker may be selected based on the reactive polymer. Examples of suitable crosslinkers include glutaraldehyde, boric acid, formaldehyde, and the like. Contacting the non-reactive base polymer with the mixture may include immersing or dip coating the base polymer in the mixture, or spraying, printing, or brushing the mixture onto the non-reactive base polymer. The mixture may penetrate the porous substrate at least part of the way such that internal surfaces, such as surfaces of individual fibers or surfaces of pores become coated. The mixture may optionally be applied in a pattern, resulting in a patterned coating.

The method may further include crosslinking the reactive polymer, the non-reactive base polymer, or both. In some embodiments, the reactive polymer only is crosslinked. In some embodiments, the reactive polymer and the non-reactive base polymer are crosslinked. The reactive polymer may become covalently bound to the non-reactive based polymer.

The method may include further steps, such as rinsing, deactivating, drying, curing, and the like, or any combination of two or more thereof. The coated substrate may be dried and/or crosslinked by exposing the coated substrate to an elevated temperature for a period of time.

The method further includes disposing the compound containing a metal on at least a portion of the coated base polymer to form the filter media. In some embodiments, chemical vapor deposition is used to dispose the compound. The chemical vapor deposition may be atomic layer deposition (ALD). Atomic layer deposition is well known to those skilled in the art and is used to grow metal oxide films on a surface. The process begins when an initiator is adsorbed to the surface of a material followed by a reactive chemical containing the metal. The initiator may be an oxygen-containing compound, such as water. The reaction of the initiator to the metal causes a monolayer of metal oxide to form on the surface. This process can be repeated in cycles until the desired thickness is obtained. The ALD reaction may use two or more precursors. A thin film may be slowly deposited through repeated exposure to separate precursors. Exemplary precursors include one or more of aluminum, antimony, arsenic, barium, beryllium, bismuth, boron, cadmium, calcium, carbon, cerium, chromium, cobalt, copper, dysprosium, erbium, europium, gadolinium, gallium, germanium, gold, hafnium, holmium, indium, iridium, iron, lanthanum, lead, lithium, lutetium, magnesium, manganese, molybdenum, neodymium, nickel, niobium, nitrogen, osmium, palladium, phosphorus, platinum, potassium, praseodymium, rhenium, rhodium, ruthenium, samarium, scandium, selenium, silicon, silver, sodium, strontium, tantalum, terbium, thallium, thulium, tin, titanium, tungsten, vanadium, xenon, ytterbium, yttrium, zinc, and zirconium. The precursor may be an organometal or a salt of a metal, or an organosilicon compound. For example, the precursor may be an organometal containing aluminum, titanium, hafnium, or a salt of aluminum or titanium. In some embodiments, the ALD precursor includes aluminum chloride, triethylaluminium, tetrakis(ethylmethylamino)titanium, titanium (IV) chloride, bis(cyclopentadienyl)dimethylhafnium, hafnium(IV) ethoxide, hexamethyldisiloxane, or a combination of one or more thereof.

### Filters

The filter media of the present disclosure may be used in a filter. The filter may include the filter media and a housing. A schematic depiction of a filter 200 is shown in FIG. 2. The filter 200 has a housing 220 defining an interior 221, an inlet 201, and an outlet 202. The filter media 210 is disposed within the interior 221 in a fluid flow path between the inlet 201 and the outlet 202. Although a cylindrical shape is shown, the filter housing 220 may have any suitable shape and size to accommodate the intended use. The filter media 210 may be provided in any desired configuration within the filter housing, including cylindrical, wrapped, pleated, planar, layered, etc. The filter media 210 may be arranged in a throughflow configuration or in a crossflow configuration.

### Methods of Using

The filter media of the present disclosure may be used to isolate compounds of interest or contaminants from a fluid. The fluid may be a gas or a liquid. The fluid may include or may be an aqueous liquid. The fluid may include or may be an organic solvent. For example, the fluid may include an aqueous solution, an aqueous beverage, an organic solvent or solution containing an organic solvent, a gas or mixture of gases, etc. In some embodiments, the fluid is a beverage such as water, beer, wine, or milk. In some embodiments, the fluid is an acidic solution or a basic solution. In some embodiments, the fluid includes an oxidizer, such as hydrogen peroxide. In some embodiments, the fluid is or includes acetonitrile, hexane, an amine solution, toluene, tetrahydrofuran (THF), ethanol, methanol, dichloromethane, or the like. In some embodiments, the fluid is a gas or a mixture of gases, such as air, helium, nitrogen, carbon dioxide, or the like. The filter media of the present disclosure may be used to isolate particulate contaminants from liquid or gas, including silicon dusts, metal particles, bacteria, viruses, ions, organic materials, etc.

According to an embodiment, a method of using the filter media of the present disclosure involves isolating a species, such as a contaminant, from a fluid. The method includes exposing the filter media to a fluid containing the species for a period of time to capture the species. The species may be adsorbed or absorbed to the filter media. The species may be removable coupled with the surface of the filter media. The filter media may be used in various separation modes, including size exclusion, interception, inertial impaction, electrostatic attraction, adsorption, absorption, coalescence, or a combination of two or more thereof.

### EXEMPLARY EMBODIMENTS

Embodiment 1 is a filter media comprising:
a porous substrate comprising a non-reactive base polymer;
a reactive polymer disposed on at least a portion of the base polymer, the reactive polymer having a surface energy that is higher than a surface energy of the non-reactive base polymer; and
a compound comprising a metal disposed on at least a portion of the reactive polymer.

Embodiment 2 is the filter media of embodiment 1, wherein the porous substrate comprises a porous network of fibers (e.g., nonwoven media), a porous membrane, or another porous structure, such as ePTFE.

Embodiment 3 is the filter media of embodiment 1 or 2, wherein the porous substrate comprises a membrane.

Embodiment 4 is the filter media of any one of embodiments 1-3, wherein the compound comprises a metal conformally disposed on at least a portion of the reactive polymer.

Embodiment 5 is the filter media of any one of embodiments 1-4, wherein the compound comprises MₙXₘ, MₙOₘ, MₙNₘ, MₙSₘ, MₙCₘ, or MₙRₘ,
wherein M is a metal,
X is a halogen, and
R is a carbon-containing straight, branched, or cyclic group, optionally substituted with one or more hetero atoms,
n is an integer from 1 to 4, 1 to 3, 1 to 2, or 1 and
m is an integer from 1 to 6, 1 to 5, 1 to 4, 1 to 3, 1 to 2, or 1.

Embodiment 6 is the filter media of any one of embodiments 1-5, wherein R is an alkyl group alkylene group, or a substituted alkyl or alkylene, such as an alkoxide group, an alkylamine group, an alkylamide group.

Embodiment 7 is the filter media of any one of embodiments 1-6, wherein R comprises acetylacetonate, cyclopentandienyl, butoxide, ethoxide, methoxide, propoxide, methylamino, ethylamino, or ethylmethylamino.

Embodiment 8 is the filter media of any one of embodiments 1-7, wherein the metal M comprises aluminum, calcium, copper, erbium, gallium, hafnium, iridium, lanthanum, magnesium, palladium, platinum, niobium, ruthenium, scandium, silicon, strontium, tantalum, titanium, vanadium, yttrium, ytterbium, zinc, zirconium, or a combination of two or more thereof.

Embodiment 9 is the filter media of any one of embodiments 1-8, wherein the non-reactive base polymer comprises polytetrafluoroethylene, (PTFE), expanded polytetrafluoroethylene (ePTFE), expanded polyethylene, expanded polypropylene, sulfonated tetrafluoroethylene, polyvinyl fluoride, oleophobic polyethersulfone, polypropylene, polyethylene, ethylene-vinyl acetate, poly dimethyl siloxane, neoprene, polyisobutylene, poly methyl vinyl ether, polybutadiene, polypropylene glycol, or a mixture or copolymer of two or more thereof.

Embodiment 10 is the filter media of any one of embodiments 1-9, wherein the non-reactive base polymer comprises an oleophobic polymer or an oleophobic treatment or both.

Embodiment 11 is the filter media of any one of embodiments 1-10, wherein the reactive polymer comprises polyvinyl alcohol (PVOH), polymethylmethacrylate (PMMA), polyacrylic acid (PAA), polyhydroxyethylmethacrylate (pHEMA), poly(caprolactam), polyethylene terephthalate (PET), polyethyleneglycol (PEG), polysulfone (PS), polyacrylonitrile (PAN), polyacrylamide (PAM), or any combination of two or more thereof.

Embodiment 12 is the filter media of any one of embodiments 1-11, wherein the reactive polymer comprises polyvinyl alcohol (PVOH).

Embodiment 13 is the filter media of any one of embodiments 1-12, wherein the filter media comprises 1 wt-% or more, 2 wt-% or more, 5 wt-% or more, 10 wt-% or more, 15 wt-% or more, or 20 wt-% or more of the metal compound as measured by the TGA Test Method.

Embodiment 14 is the filter media of any one of embodiments 1-13, wherein the filter media has a permeability of 0.02 cm³/s/cm² or greater, 0.05 cm³/s/cm² or greater, 0.1 cm³/s/cm² or greater, 0.2 cm³/s/cm² or greater, 0.3 cm³/s/cm² or greater, or 0.5 cm³/s/cm² or greater. The permeability of the filter media 10, 110 may be 2 cm³/s/cm² or less, 1.5 cm³/s/cm² or less, 1.0 cm³/s/cm² or less, or 0.8 cm³/s/cm² or less.

Embodiment 15 is the filter media of any one of embodiments 1-14, wherein the filter media comprises a first major surface and an opposing second major surface and a thickness between the first and second major surfaces, and wherein 20 wt-% or more of the compound including metal is disposed within the thickness as determined by elemental analysis of a cross section of the filter media.

Embodiment 16 is the filter media of any one of embodiments 1-15, wherein at least 20 wt-% of the compound is distributed throughout the thickness.

Embodiment 17 is the filter media of any one of embodiments 1-16, wherein the filter media comprises a plurality of regions comprising the reactive polymer.

Embodiment 18 is the filter media of any one of embodiments 1-17, wherein the filter media comprises a plurality of regions comprising the compound.

Embodiment 19 is the filter media of any one of embodiments 1-18, wherein the porous substrate of fibers comprises an expanded non-reactive base polymer.

Embodiment 20 is the filter media of any one of embodiments 1-19, wherein the non-reactive base polymer comprises expanded polytetrafluoroethylene (ePTFE), expanded polyethylene, or expanded polypropylene, preferably wherein the non-reactive base polymer comprises ePTFE.

Embodiment 21 is a filter comprising a housing and the filter media of any one of embodiments 1-20 disposed within the housing.

Embodiment 22 is the filter of any one of embodiments 1-21, wherein the housing comprises an inlet and an outlet and a fluid flow path extending from the inlet to the outlet and extending through or across the filter media.

Embodiment 23 is a method of isolating species, the method comprising:

exposing the filter media of any one of embodiments 1-22 to a fluid comprising the species and capturing the species on the filter media.

Embodiment 24 is the method of embodiment 23, wherein the method further comprises removing the species from the filter media to regenerate the filter media.

Embodiment 25 is the method of embodiment 23 or 24, wherein the species comprises a contaminant.

Embodiment 26 is a method of making the filter media of any one of embodiments 1-22, the method comprising:
contacting at least a portion of the non-reactive base polymer with a mixture to form a coated base polymer, the mixture comprising:
a reactive polymer; and
a carrier; and
disposing the compound comprising a metal on at least a portion of the coated base polymer to form the filter media.

Embodiment 27 is the method of embodiment 26, wherein the non-reactive base polymer is wettable, and the method further comprises contacting at least a portion of the non-reactive base polymer with a wetting liquid.

Embodiment 28 is the method of embodiment 26 or 27, wherein the non-reactive base polymer comprises polytetrafluoroethylene (PTFE), expanded polytetrafluoroethylene (ePTFE), sulfonated tetrafluoroethylene, polyvinyl fluoride, oleophobic polyethersulfone (for example, PES coated with an oleophobic coating), polypropylene, non-woven polypropylene, polyethylene, ethylene-vinyl acetate, poly dimethyl siloxane, neoprene, polyisobutylene, poly methyl vinyl ether, polybutadiene, polypropylene glycol, any combination of two or more thereof (including mixtures and copolymers), nonwoven materials made thereof, and membranes made thereof. In some embodiments, the non-reactive material (e.g., polymer) includes an oleophobic polymer or an oleophobic treatment or both. The wetting liquid comprises isopropanol, acetone, ethanol, ethylamine, ethylene glycol, acetonitrile, methanol, 1-propanol, or pyridine.

Embodiment 29 is the method of any one of embodiments 26-28, wherein the method further comprises crosslinking the reactive polymer, the non-reactive base polymer, or both, of the coated base polymer.

Embodiment 30 is the method of any one of embodiments 26-29, wherein crosslinking further comprises exposing the coated base polymer to an elevated temperature for a period of time.

Embodiment 31 is the method of any one of embodiments 26-30, wherein the mixture further comprises a crosslinker.

Embodiment 32 is the method of any one of embodiments 26-31, wherein disposing the compound further comprises using chemical vapor deposition.

Embodiment 33 is the method of any one of embodiments 26-32, wherein chemical vapor deposition comprises atomic layer deposition.

Embodiment 34 is the method of any one of embodiments 26-33, wherein the porous substrate comprises a porous network of fibers (e.g., nonwoven media), a porous membrane, or another porous structure, such as ePTFE.

Embodiment 35 is the method of any one of embodiments 26-34, wherein the porous substrate comprises a membrane.

Embodiment 36 is the method of any one of embodiments 26-35, wherein the compound comprises a metal conformally disposed on at least a portion of the reactive polymer.

Embodiment 37 is the method of any one of embodiments 26-36, wherein the compound comprises MₙXₘ, MₙOₘ, MₙNₘ, MₙSₘ, MₙCₘ, or MₙRₘ,
wherein M is a metal,
X is a halogen, and
R is a carbon-containing straight, branched, or cyclic group, optionally substituted with one or more hetero atoms,
n is an integer from 1 to 4, 1 to 3, 1 to 2, or 1 and
m is an integer from 1 to 6, 1 to 5, 1 to 4, 1 to 3, 1 to 2, or 1.

Embodiment 38 is method of any one of embodiments 26-37, wherein R is an alkyl group, alkylene group, or a substituted alkyl or alkylene, such as an alkoxide group, an alkylamine group, an alkylamide group.

Embodiment 39 is the method of any one of embodiments 26-38, wherein R comprises acetylacetonate, cyclopentandienyl, butoxide, ethoxide, methoxide, propoxide, methylamino, ethylamino, or ethylmethylamino.

Embodiment 40 is the method of any one of embodiments 26-39, wherein the reactive polymer comprises polyvinyl alcohol (PVOH), polymethylmethacrylate (PMMA), polyacrylic acid (PAA), polyhydroxyethylmethacrylate (pHEMA), poly(caprolactam), polyethylene terephthalate (PET), polyethyleneglycol (PEG), polysulfone (PS), polyacrylonitrile (PAN), polyacrylamide (PAM), or any combination of two or more thereof.

Embodiment 41 is the method of any one of embodiments 26-40, wherein the reactive polymer comprises polyvinyl alcohol (PVOH).

Embodiment 42 is the method of any one of embodiments 26-41, wherein the filter media comprises 1 wt-% or more, 2 wt-% or more, 5 wt-% or more, 10 wt-% or more, 15 wt-% or more, or 20 wt-% or more of the metal compound as measured by the TGA Test Method.

Embodiment 43 is the method of any one of embodiments 26-42, wherein the filter media has a permeability of 0.02 cm³/s/cm² or greater, 0.05 cm³/s/cm² or greater, 0.1 cm³/s/cm² or greater, 0.2 cm³/s/cm² or greater, 0.3 cm³/s/cm² or greater, or 0.5 cm³/s/cm² or greater. The permeability of the filter media 10, 110 may be 2 cm³/s/cm² or less, 1.5 cm³/s/cm² or less, 1.0 cm³/s/cm² or less, or 0.8 cm³/s/cm² or less.

Embodiment 44 is the method of any one of embodiments 26-43, wherein the filter media comprises a first major surface and an opposing second major surface and a thickness between the first and second major surfaces, and wherein 20 wt-% or more of the compound including metal is disposed within the thickness as determined by elemental analysis of a cross section of the filter media.

Embodiment 45 is the method of any one of embodiments 26-44, wherein at least 20 wt-% of the compound is distributed throughout the thickness.

Embodiment 46 is the method of any one of embodiments 26-45, wherein the filter media comprises a plurality of regions comprising the reactive polymer.

Embodiment 47 is the method of any one of embodiments 26-46, wherein the filter media comprises a plurality of regions comprising the compound.

Embodiment 48 is the method of any one of embodiments 26-47, wherein the porous substrate of fibers comprises an expanded non-reactive base polymer.

Embodiment 49 is the method of any one of embodiments 26-48, wherein the non-reactive base polymer comprises expanded polytetrafluoroethylene (ePTFE), expanded polyethylene, or expanded polypropylene, preferably wherein the non-reactive base polymer comprises ePTFE.

Embodiment 50 is the method of any one of embodiments 26-49, wherein the metal M comprises aluminum, calcium, copper, erbium, gallium, hafnium, iridium, lanthanum, magnesium, palladium, platinum, niobium, ruthenium, scandium, silicon, strontium, tantalum, titanium, vanadium, yttrium, ytterbium, zinc, zirconium, or a combination of two or more thereof.

Embodiment 51 is the filter media of any one of embodiments 1-20, the filter embodiments 21-22, or the method of any one of embodiments 26-50, wherein the compound comprises Al₂O₃, CaO, CuO, Er₂O₃, Ga₂O₃, HfO₂, La₂O₃, MgO, Nb₂O₅, Sc₂O₃, SiO₂, Ta₂O₅, TiO₂, vanadium acetylacetonate, vanadium cyclopentandienyl, vanadium butoxide, vanadium ethoxide, vanadium methoxide, vanadium propoxide, vanadium tetraethoxide, Y₂O₃, Yb₂O₃, ZnO, ZrO₂, AlN, GaN, pentakis(dimethylamino)tantalum, TiAlN, tetrakis(dimethylamino)titanium, tetrakis(ethylmethylamino)titanium, TaC, TiC, Ir, Pd, Pt, Ru, ZnS, SrS, CaF₂, LaF₃, MgF₂, SrF₂, or a combination of any two or more thereof.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, MO; Carus, Peru, IL; Calgon Carbon, Moon Township, PA; Ultramet, Los Angeles, CA; or may be synthesized by conventional methods.

The following abbreviations may be used in the following examples: mL=milliliter, L=liter, m=meter, mm=millimeter, min=minutes, s=seconds, cm=centimeter, μm=micrometer, kg=kilogram, g=gram, min=minute, s=second, h=hour, ° C.=degrees Celsius, ° F.=degrees Fahrenheit; wt-%=weight percent; M=molar; and DI water=deionized water.

### Test Methods:

### Thermogravimetric Analysis (TGA)

Thermogravimetric analysis was performed according to ASTM-E1131-20 is used to measure wt-% of the metal compound as measured by the TGA.

### Imaging Using SEM/EDX

Visual and elemental images were generated using a JEOL JSM-5900LV Scanning Electron Microscope (SEM) with an E-DAX EDS Si/Li detector (EDX). A 1 cm by 5 cm rectangle of sample is cut from the media. The sample is mounted, cut side up, on a notched cross section stub, and imaged using the SEM.

### Permeability Test

To measure the Frazier permeability of a filter media, the volume of air at a given pressure flowing through a given area of the porous material under pressure may be measured using known methods, such as ASTM D737-18. Frazier permeability may be measured using a Frazier Permeability Tester available from Frazier Precision Instrument Co. Inc., Gaithersburg, Maryland. The measurement may be conducted over a circular test area of 0.6 in². Frazier permeability is usually given in units of cfm/ft² at 0.5″ water pressure drop (1 cfm/ft² at 0.5″ water pressure drop is equivalent to 0.5 cm³/s/cm² at 125 Pa).

### Porometry Test

It is possible to evaluate the filter media of the present invention on the basis of media pore structure. Media pore structure can be characterized on the basis of capillary theory of porometry. Capillary theory of porometry relies on the assumption that there is a balance of forces between the hydrostatic head pressure of the liquid and the forces from the surface tension. The force balance of capillary forces in a pore may be calculated according to the following equation derived from the Young-Laplace equation:

$$σ π d cos ( θ ) - γ ( Δ h ) ( \frac{π {d}^{2}}{4} ) = 0$$

where σ (sigma)=surface tension;
d=diameter of tube;
θ (theta)=contact angle of liquid on surface of tube;
γ (gamma)=specific weight of fluid;
Δh=fluid displacement distance in tube.

For wettable fluids, the contact angle is small, and it can be assumed that cos(θ)≈1

After substituting pressure for specific weight and liquid height, the equation can be written as:

$$d = ( \frac{4 σ}{Δ p} )$$

This equation relates diameter, pressure, and surface tension and is used in the calculation of pore size in porometry testing.

The pore size measurements for each membrane were conducted according to ASTM D6767-21. Such pore testing can be accomplished by utilizing, for example, an automated air permeability porometer manufactured by Porous Materials, Inc. As used herein, the model was APP-1200-AEXSC using CAPWIN Version 6.71.122 test software. The test procedure included capillary flow porometry, dry up/wet up using silicone fluid and a fluid surface tension of 20.1 dynes/c. The sample effective testing size had a diameter of 1.0 centimeters, with a maximum air flow of 100,000 cc/min and a maximum sample differential pressure of 120 kP.

To calculate the pore size distribution from the data, the dry sample curve is compared to the wet sample curve. This is done by calculating the percent of air flow the wet sample has versus the dry sample. This gives what is called the filter flow percentage, which is a function of pressure.

$$Q ( p ) = \frac{Wet Sample Air {Flow}_{p}}{Dry Sample Air {Flow}_{p}}$$

Using a capillary theory equation, diameter is substituted for pressure, which gives a flow base pore size distribution curve from 0-100%.

$$D ( d ) = Q ( \frac{4 σ}{d} ) = Q ( p )$$

Raw data collected from tests may be curve-fit into a distribution format without having to restrict it into a classical normal distribution curve. The results of this technique give:
g (d)=a cumulative distribution function of the diameter of the pore sizes of the tested sample.
G (d)=a density distribution function of the diameter of the pore sizes of the tested sample.

### Water Flux Test

Water flux measurements were generated by adding 5 gallons of water to a pressure vessel, pressurizing it to 10 psi, connecting it to a filter patch holder and opening a valve between the vessel and the filter patch holder. The volume of water that came through the filter was captured in a graduated cylinder and measured after 30 seconds for all samples. Filter patches had an active area of 47 mm in diameter. Water flux may be given as liters per square meter per minute per psi (L/m²/min/psi).

### Example 1

Samples of base material were imaged with and without a poly(vinyl alcohol) (PVOH) coating. The base material was a sheet of ePTFE membrane available as Tx1303 from Donaldson Company in Bloomington, MN. The membrane was coated with PVOH by methods known to persons skilled in the art, including prewetting the membrane with a solvent, immersing the membrane in a solution of PVOH, and rinsing the membrane.

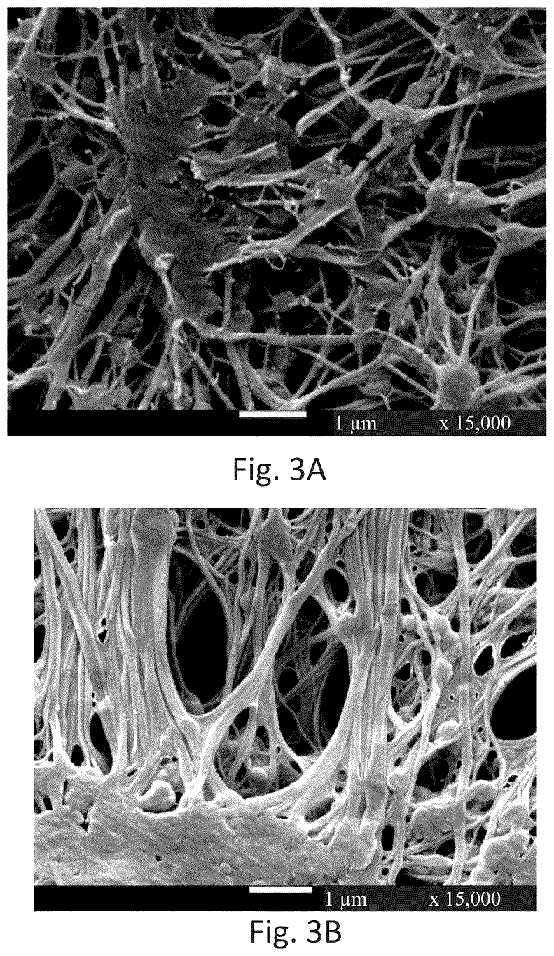

Visual images were generated using a JEOL JSM-5900LV Scanning Electron Microscope. SEM images are shown in FIGS. 3A (uncoated sample) and 3B (PVOH coated sample).

### Example 2

The base material Tx1303 was treated with Al₂O₃ by atomic layer deposition for 100 cycles and 300 cycles. One set of samples was first coated with PVOH as described in Example 1. Another set was treated with Al₂O₃ without PVOH coating. Atomic layer deposition of Al₂O₃ on the base material was performed at 150° C. at 1 mbar pressure. Each cycle was 6 seconds long, including 3 seconds for the initiator (water) and 3 seconds for the precursor (trimethylaluminum).

Visual and elemental images were generated using a JEOL JSM-5900LV Scanning Electron Microscope. The Frazier permeability of a filter media was measured by Permeability test. Pore structure was characterized on the basis of capillary theory of porometry. Water flux was measured by Water Flux Test.

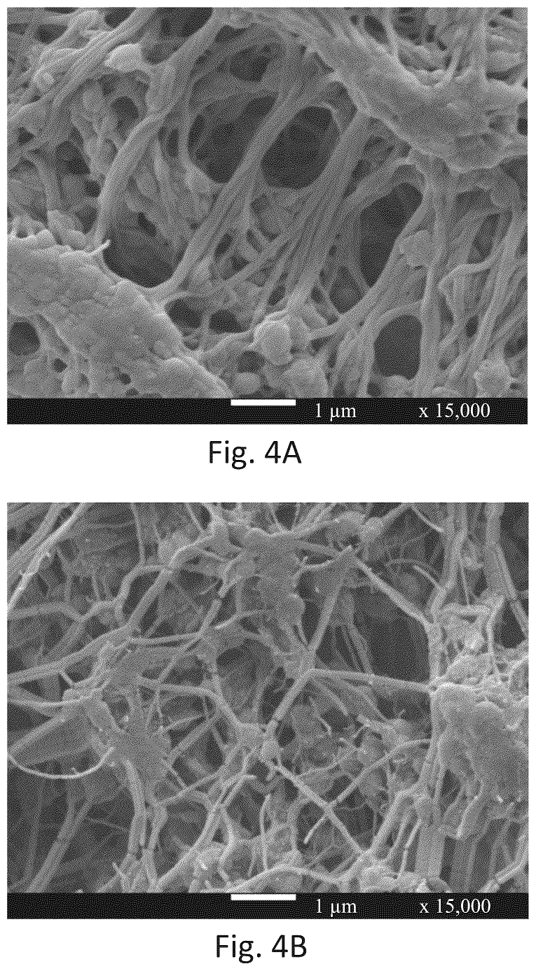

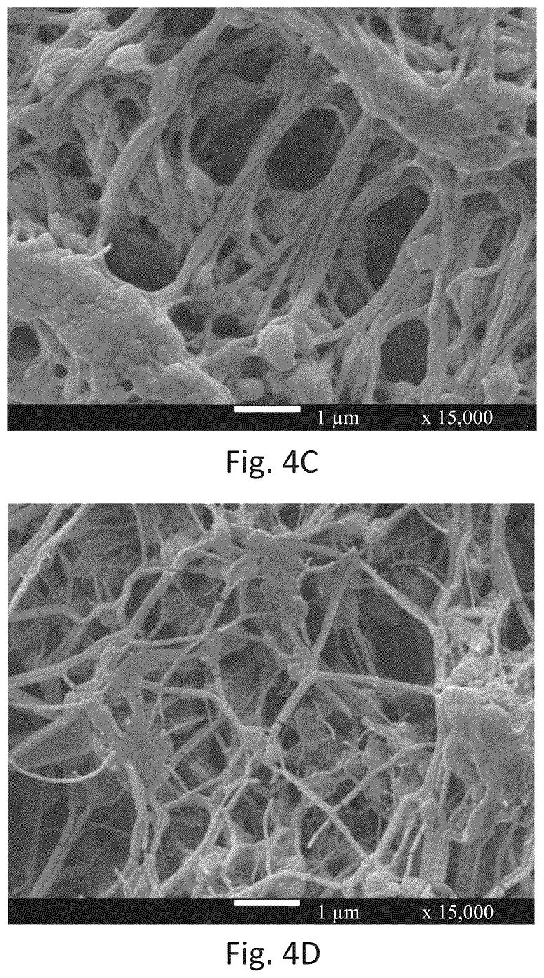

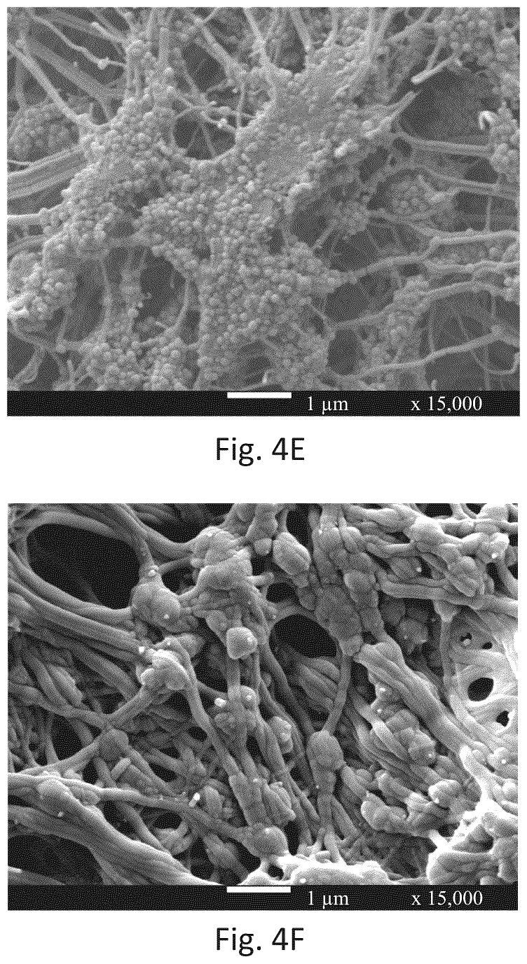

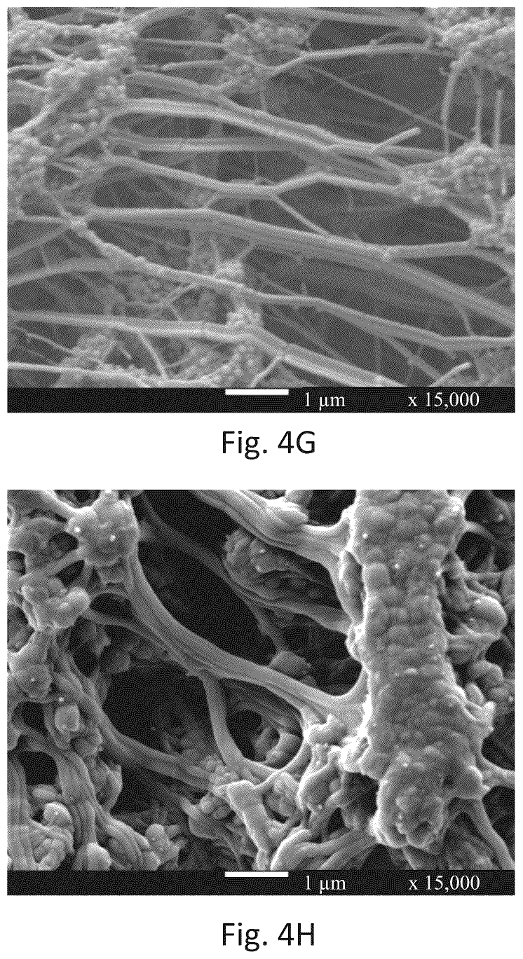

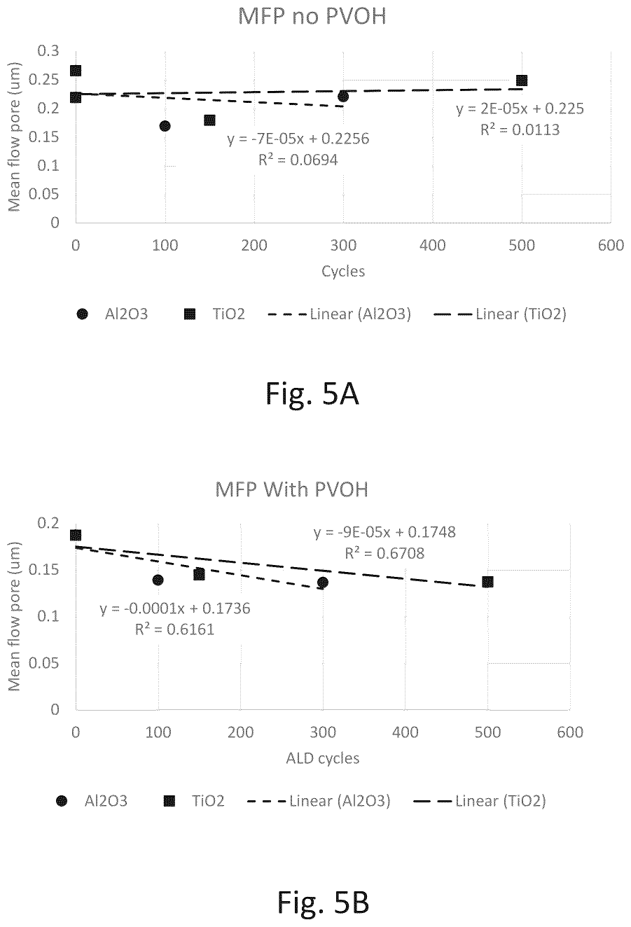

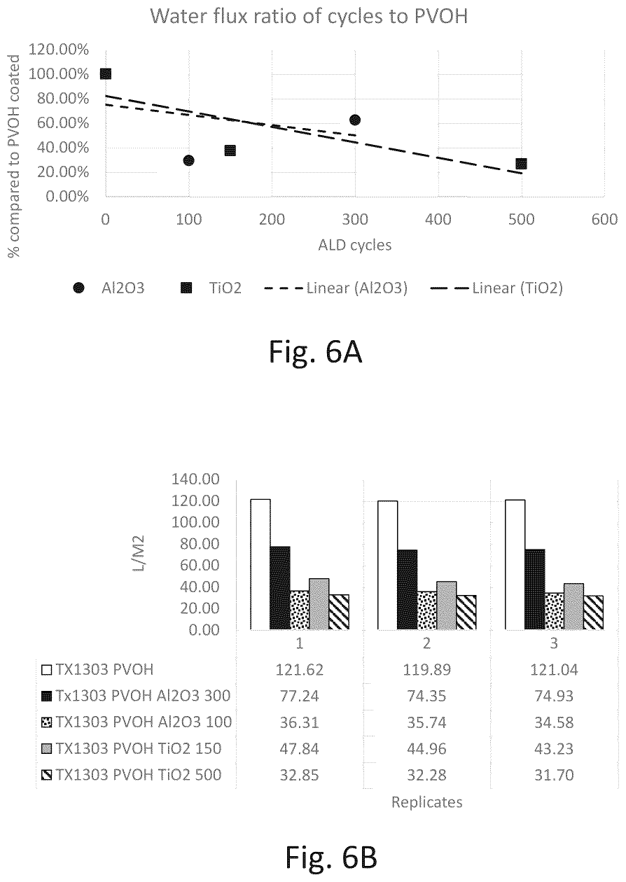

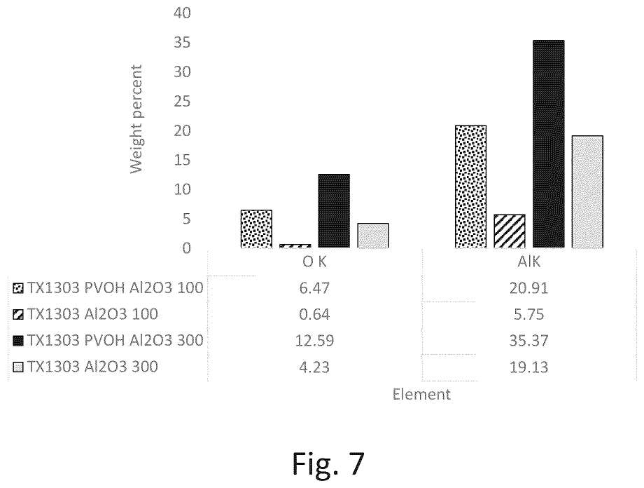

SEM images were obtained at 15,000× magnification. The SEM images of nodular and fibrous portions of the samples are shown in FIGS. 4A (nodular portion) and 4C (fibrous portion) with no PVOH, 100 cycles Al₂O₃; FIGS. 4B (nodular portion) and 4D (fibrous portion) with PVOH, 100 cycles Al₂O₃; FIGS. 4E (nodular portion) and 4G (fibrous portion) with no PVOH, 300 cycles Al₂O₃; FIGS. 4F (nodular portion) and 4H (fibrous portion) with PVOH, 300 cycles Al₂O₃. The porometry results (along with samples from Example 3) are shown in FIGS. 5A (no PVOH) and 5B (with PVOH); the water flux results are shown in FIGS. 6A (no PVOH) and 6B (with PVOH); and the elemental analysis (EDX) results are shown in FIG. 7.

It was observed that samples first treated with PVOH appeared more yellow than non-treated samples.

### Example 3

The base material Tx1303 was treated with TiO₂ by atomic layer deposition for 150 cycles and 500 cycles. One set of samples was first coated with PVOH as described in Example 1. Another set was treated with TiO₂ without PVOA coating. ALD deposition of TiO₂ on the base material was performed at 150° C. at 1 mbar pressure. Each cycle was 6 seconds long, including 3 seconds for the initiator (water) and 3 seconds for the precursor (tetrakis(dimethylamino)titanium (IV)).

Visual and elemental images are generated using a JEOL JSM-5900LV Scanning Electron Microscope. the Frazier permeability of a filter media is measured by Permeability test. Pore structure of the filter media of the present invention is characterized on the basis of capillary theory of porometry. Water flux of the present invention is measured by Water flux test.

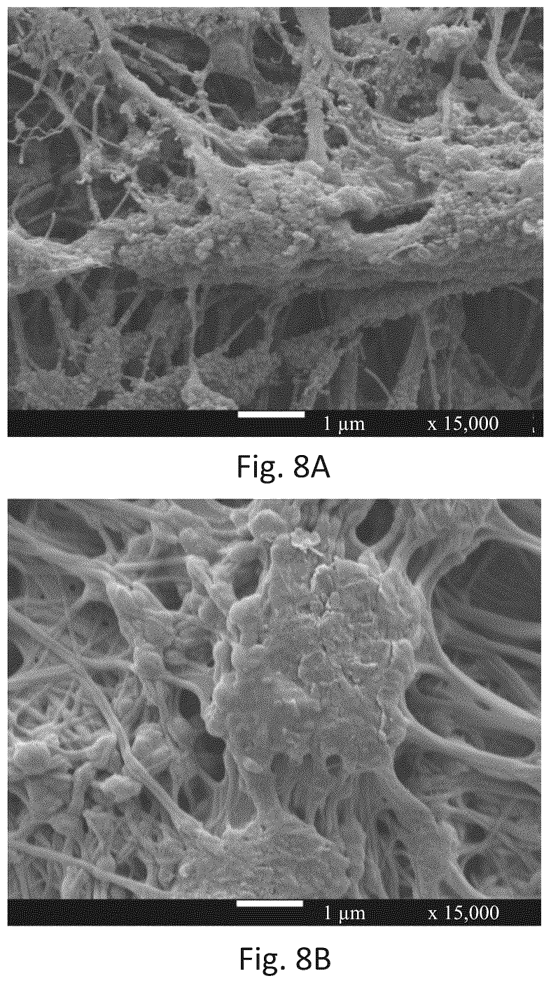

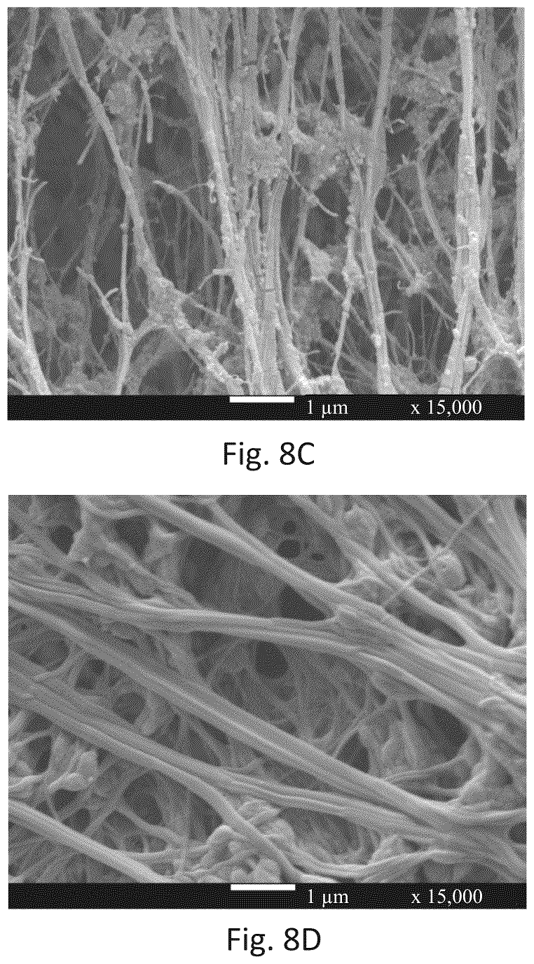

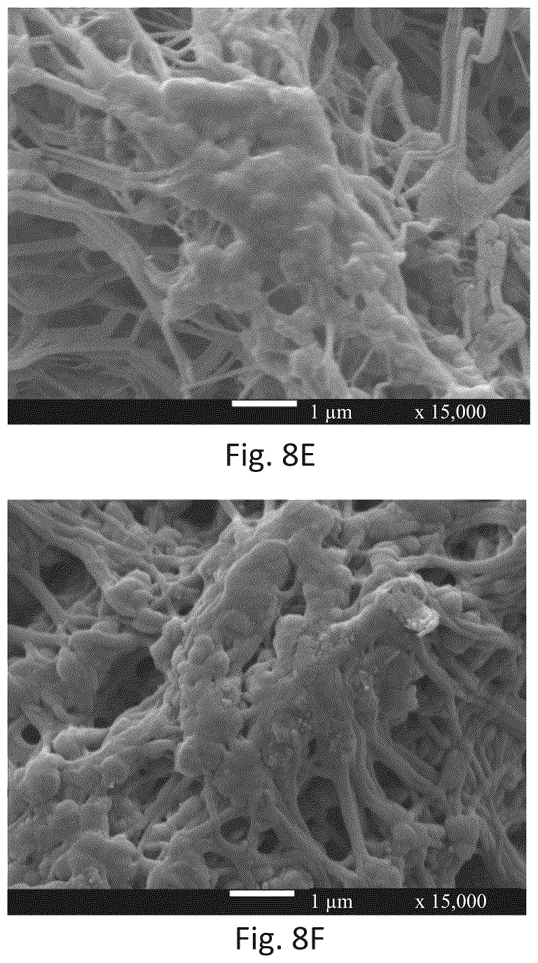

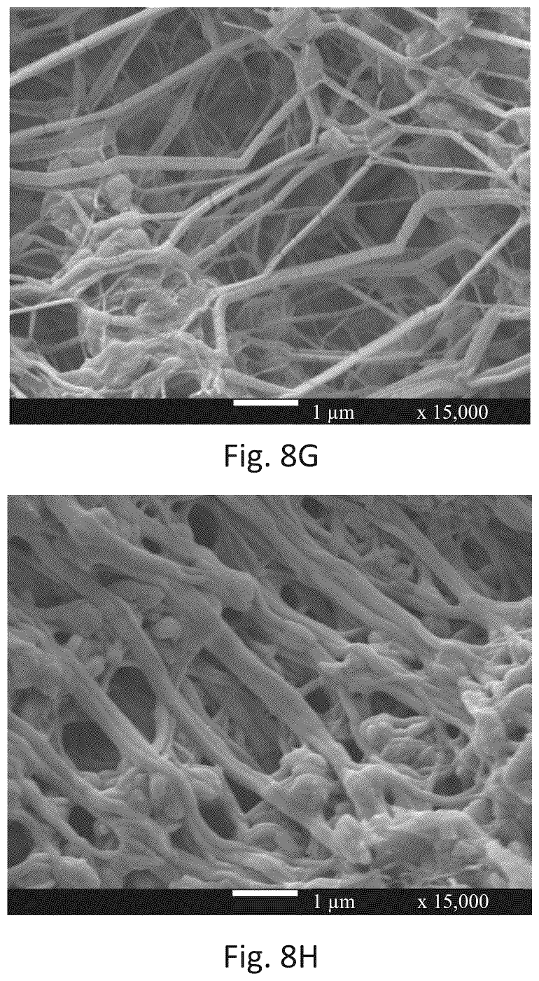

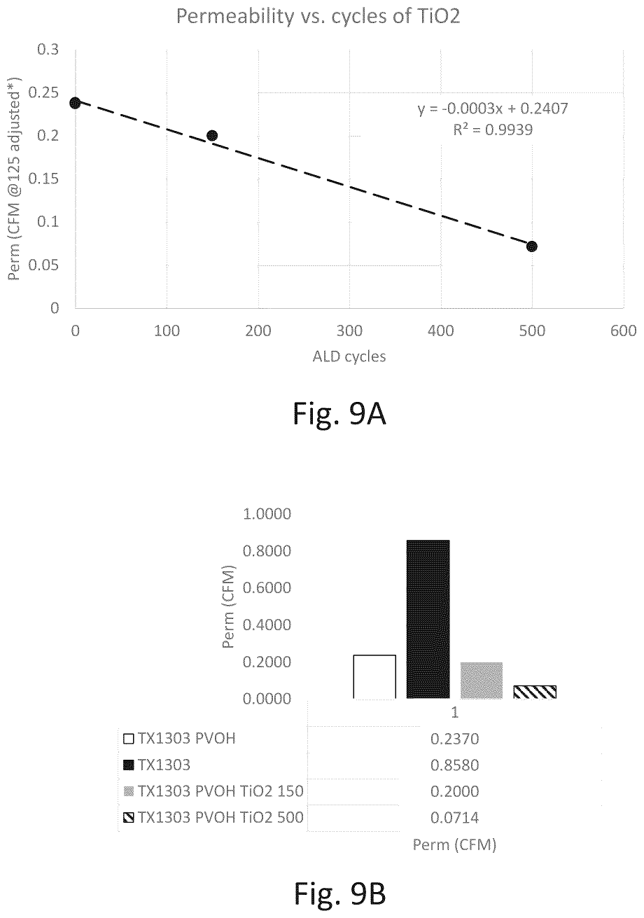

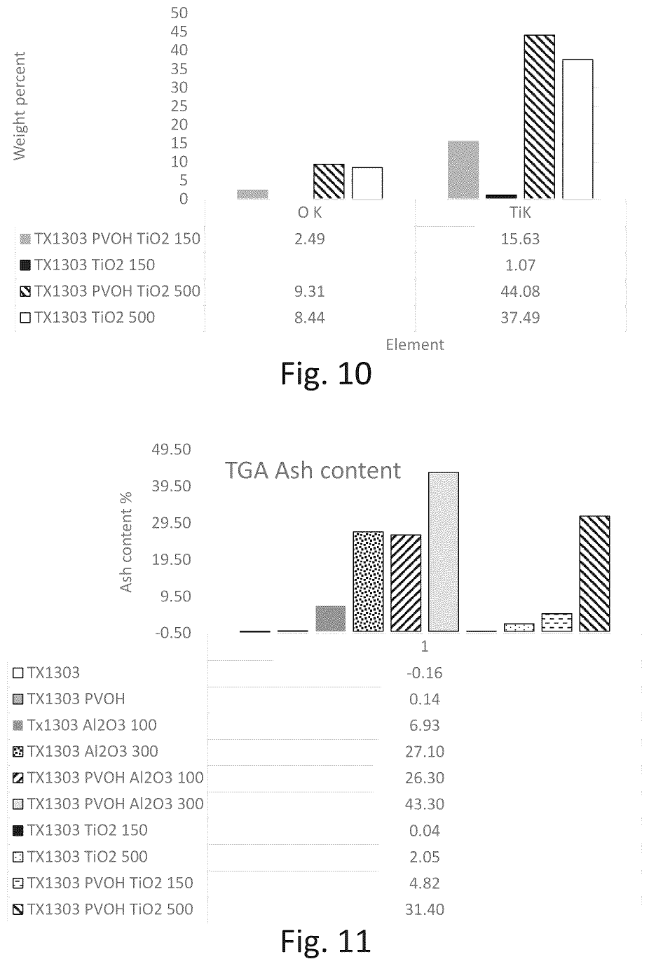

SEM images were obtained at 15,000× magnification. The SEM images of nodular and fibrous portions of the samples are shown in FIGS. 8A (nodular portion) and 8C (fibrous portion) with no PVOH, 150 cycles TiO₂; FIGS. 8B (nodular portion) and 8D (fibrous portion) with PVOH, 150 cycles TiO₂; FIGS. 8E (nodular portion) and 8G (fibrous portion) with no PVOH, 500 cycles TiO₂; FIGS. 8F (nodular portion) and 8H (fibrous portion) with PVOH, 500 cycles TiO₂. The permeability results are shown in FIGS. 9A and 9B; the elemental analysis (EDX) results are shown in FIG. 10, and the TGA results are shown in FIG. 11.

It was observed that adding a high surface energy coating, such as PVOH, to a material like PTFE can change the metal oxide uptake rate significantly. The present disclosure provides that polyvinyl alcohol (PVOH) coatings increase the uptake rate for both Al₂O₃ and TiO₂ coatings on ePTFE. The samples that did not have the PVOH coating showed more nodular growth that is indicative of low activity on the surface of the polymer. For the samples treated we seen smoother fibers indicating better coverage. The TGA results verify the increased pickup as the difference in ash content as well as the differences seen in the EDX data. It was observed that samples first treated with PVOH appeared more gray than non-treated samples.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A filter media comprising:
a porous substrate comprising a non-reactive base polymer;
a reactive polymer disposed on at least a portion of the base polymer, the reactive polymer having a surface energy that is higher than a surface energy of the non-reactive base polymer; and
a compound comprising a metal disposed on at least a portion of the reactive polymer.

2. The filter media of claim 1, wherein the porous substrate comprises a porous network of fibers.

3. The filter media of claim 1, wherein the porous substrate comprises a membrane.

4. The filter media of claim 1 wherein the compound comprises a metal conformally disposed on at least a portion of the reactive polymer.

5. The filter media of claim 1, wherein the compound comprises MₙXₘ, MₙOₘ, MₙNₘ, MₙSₘ, MₙCₘ, or MₙRₘ,
wherein M is a metal,
X is a halogen, and
R is a carbon-containing straight, branched, or cyclic group, optionally substituted with one or more hetero atoms,
n is an integer from 1 to 4, and
m is an integer from 1 to 6.

6. The filter media of claim 1, wherein the non-reactive base polymer comprises polytetrafluoroethylene, (PTFE), expanded polytetrafluoroethylene (ePTFE), expanded polyethylene, expanded polypropylene, sulfonated tetrafluoroethylene, polyvinyl fluoride, oleophobic polyethersulfone, polypropylene, polyethylene, ethylene-vinyl acetate, poly dimethyl siloxane, neoprene, polyisobutylene, poly methyl vinyl ether, polybutadiene, polypropylene glycol, or a mixture or copolymer of two or more thereof.

7. The filter media of claim 1, wherein the non-reactive base polymer comprises an oleophobic polymer or an oleophobic treatment or both.

8. The filter media of claim 1, wherein the reactive polymer comprises polyvinyl alcohol (PVOH), polymethylmethacrylate (PMMA), polyacrylic acid (PAA), polyhydroxyethylmethacrylate (pHEMA), poly(caprolactam), polyethylene terephthalate (PET), polyethyleneglycol (PEG), polysulfone (PS), polyacrylonitrile (PAN), polyacrylamide (PAM), or any combination of two or more thereof.

9. The filter media of claim 1, wherein the filter media comprises 2 wt-% or greater of the metal compound as measured by the TGA Test Method.

10. The filter media of claim 1, wherein the filter media has a permeability of 0.02 cm³/s/cm² or greater.

11. The filter media of claim 1, wherein the filter media comprises a first major surface and an opposing second major surface and a thickness between the first and second major surfaces, and wherein 20 wt-% or more of the compound including metal is disposed within the thickness as determined by elemental analysis of a cross section of the filter media.

12. The filter media of claim 11, wherein at least 20 wt-% of the compound is distributed throughout the thickness.

13. The filter media of claim 1, wherein the filter media comprises a plurality of regions comprising the reactive polymer.

14. The filter media of claim 1, wherein the filter media comprises a plurality of regions comprising the compound.

15. The filter media of claim 1, wherein the porous substrate of fibers comprises an expanded non-reactive base polymer.

16. A filter comprising a housing and the filter media of claim 1 disposed therein.

17. A method of isolating species, the method comprising:
exposing filter media to a fluid comprising the species and capturing the species on the filter media, the filter media comprising:
a porous substrate comprising a non-reactive base polymer;
a reactive polymer disposed on at least a portion of the base polymer, the reactive polymer having a surface energy that is higher than a surface energy of the non-reactive base polymer; and
a compound comprising a metal disposed on at least a portion of the reactive polymer.

18. The method of claim 17, wherein the method further comprises removing the species from the filter media to regenerate the filter media.

19. The method of claim 17, wherein the species comprises a contaminant.

20. A method of making filter media comprising:
a porous substrate comprising a non-reactive base polymer;
a reactive polymer disposed on at least a portion of the base polymer, the reactive polymer having a surface energy that is higher than a surface energy of the non-reactive base polymer; and
a compound comprising a metal disposed on at least a portion of the reactive polymer,
the method comprising:
contacting at least a portion of the non-reactive base polymer with a mixture to form a coated base polymer, the mixture comprising:
a reactive polymer; and
a carrier; and
disposing the compound comprising a metal on at least a portion of the coated base polymer to form the filter media.

21. The method of claim 20, wherein the non-reactive base polymer is wettable, and the method further comprises contacting at least a portion of the non-reactive base polymer with a wetting liquid.

22. The method of claim 21, wherein the non-reactive base polymer comprises polytetrafluoroethylene and the wetting liquid comprises isopropanol.

23. The method of claim 20, wherein the method further comprises crosslinking the reactive polymer, the non-reactive base polymer, or both, of the coated base polymer.

24. The method of claim 23, wherein crosslinking further comprises exposing the coated base polymer to an elevated temperature for a period of time.

25. The method of claim 23, wherein the mixture further comprises a crosslinker.

26. The method of claim 20, wherein disposing the compound further comprises using chemical vapor deposition.

27. The method of claim 26, wherein the chemical vapor deposition comprises atomic layer deposition.

28. The filter media of claim 5, wherein the metal M comprises aluminum, calcium, copper, erbium, gallium, hafnium, iridium, lanthanum, magnesium, palladium, platinum, niobium, ruthenium, scandium, silicon, strontium, tantalum, titanium, vanadium, yttrium, ytterbium, zinc, zirconium, or a combination of two or more thereof.

29. The filter media of claim 1, wherein the compound comprises Al₂O₃, CaO, CuO, Er₂O₃, Ga₂O₃, HfO₂, La₂O₃, MgO, Nb₂O₅, Sc₂O₃, SiO₂, Ta₂O₅, TiO₂, vanadium acetylacetonate, vanadium cyclopentandienyl, vanadium butoxide, vanadium ethoxide, vanadium methoxide, vanadium propoxide, vanadium tetraethoxide, Y₂O₃, Yb₂O₃, ZnO, ZrO₂, AlN, GaN, pentakis(dimethylamino)tantalum, TiAlN, tetrakis(dimethylamino)titanium, tetrakis(ethylmethylamino)titanium, TaC, TiC, Ir, Pd, Pt, Ru, ZnS, SrS, CaF₂, LaF₃, MgF₂, SrF₂, or a combination of any two or more thereof.
